(19) United States
(12) Patent Application Publication
(10) Pub. No.: US 2014/0374105 A1
(43) Pub. Date: Dec. 25, 2014

(54) PROCESS FOR THE REMOVAL OF CARBON DIOXIDE FROM A GAS

(71) Applicant: SHELL INTERNATIONALE RESEARCH MAATSCHAPPIJ B.V., THE HAGUE (NL)

(72) Inventor: Jiri Peter Thomas Van Straelen, Amsterdam (NL)

(73) Assignee: SHELL OIL COMPANY, Houston, TX (US)

(21) Appl. No.: 14/351,021

(22) PCT Filed: Oct. 11, 2012
(86) PCT No.: PCT/EP2012/070209

§ 371 Date: Apr. 10, 2014

(30) Foreign Application Priority Data
Oct. 13, 2011 (EP) 11185044.2

(51) Int. Cl. B01D 53/62

(52) U.S. Cl. CPC B01D 53/62
USPC 166/305.1; 423/232

(57) ABSTRACT

Process for the removal of CO₂ from a gas comprising CO₂, comprising the steps of: (a) contacting the gas in an absorber (102) with an aqueous solution of one or more carbonate compounds in the presence of an accelerator, thereby reacting at least part of the CO₂ to form a bicarbonate compound, under conditions such that at least a part of the bicarbonate compound formed precipitates, forming a bicarbonate slurry; (b) subjecting at least part of the bicarbonate slurry to a concentration step (105) to obtain the aqueous solution and a concentrated bicarbonate slurry, wherein the concentrated bicarbonate slurry comprises in the range of from 10 to 60 wt % of bicarbonate compounds; (c) returning at least part of the aqueous solution to the absorber; (d) transferring a first part of the concentrated bicarbonate slurry to a first heat exchanger (110a), wherein the first part of the slurry is being heated against a hot lean solvent of a regenerator (112); (e) transferring a second part of the concentrated bicarbonate slurry to a second heat exchanger (110b), wherein the second part of the slurry is being heated against a second heating source, which second heating source differs from the hot lean solvent of the regenerator; (f) transferring the heated first part and the heated second part of the concentrated bicarbonate slurry to the regenerator (112) and heating concentrated bicarbonate slurry to obtain a CO₂-rich gas stream and a regenerated carbonate stream; and (g) returning the regenerated carbonate stream to the absorber (102) of step (a).

### FIELD OF THE INVENTION

The invention relates to a process for removal of carbon dioxide (CO₂) from a gas.

### BACKGROUND OF THE INVENTION

In recent years there has been a substantial global increase in the amount of carbon dioxide emission to the atmosphere. Emissions of carbon dioxide into the atmosphere are thought to be harmful due to its “greenhouse gas” property, contributing to global warming. Following the Kyoto agreement, carbon dioxide emission has to be reduced in order to prevent or counteract unwanted changes in climate. Significant sources of carbon dioxide emission are combustion of fossil fuels, for example coal or natural gas, for electricity generation; and the use of petroleum products as transportation and heating fuel. These uses result in the production of gases comprising carbon dioxide. Thus, removal of at least part of the carbon dioxide prior to emission of these gases into the atmosphere is desirable.

Processes for removal of carbon dioxide are known in the art. In general, these processes remove and recover carbon dioxide from combustion exhaust gas using a CO₂-absorbing solution. Such methods include contacting the combustion exhaust gas with the CO₂-absorbing solution in an absorption tower, heating the CO₂-rich absorbing solution in a regeneration tower whereby carbon dioxide is being released and the absorbent regenerated, and recycling the regenerated absorbing solution to the absorption tower to be reused.

The removal of carbon dioxide will become a necessary part in future power plants. In the conventional methods, the steps of removing carbon dioxide from the flue gases, and, especially, the regeneration of the CO₂-rich absorbent to recover the lean absorbent and pure carbon dioxide are expensive to operate. Particularly, the regeneration process consumes a large amount of heating energy. Therefore, there is a need to save energy in the operation of the regeneration process.

In WO2010/146167, a process for the removal of carbon dioxide and/or hydrogen sulphide is described wherein in the regeneration step at least part of the heat for heating the CO₂ and/or H₂S rich absorbing solution is obtained in a sequence of multiple heat exchangers. A disadvantage of the process is that the use of the heat source in the heat exchangers is not optimal.

WO 2008/072979 describes a method for capturing carbon dioxide from exhaust gas in an absorber, wherein the carbon dioxide containing gas is passed through an aqueous absorbent slurry comprising an inorganic alkali carbonate, bicarbonate and at least one of an absorption promoter and a catalyst, wherein the carbon dioxide is converted to solids by precipitating bicarbonate in the absorber. The slurry containing the bicarbonates is conveyed to a separating device in which the solids are separated off. The solids are sent to a heat exchanger, where it is heated and sent to a desorber. In the desorber it is heated further to the desired desorber temperature. A disadvantage of this process is that the heating and dissolution of the solids before and in the desorber is energy intensive, especially when a reboiler is used.

In WO 2009/153351, also a process for the removal of carbon dioxide from gases is described, whereby precipitating bicarbonate is formed to capture the carbon dioxide. Also in this case a disadvantage is that the heating and dissolution of the solids before and in the desorber is energy intensive, especially when a reboiler is used.

Thus, there remains a need for an improved simple and energy-efficient process for removal of carbon dioxide from gases in which process solids are being precipitated.

Furthermore, there remains a need to improve the energy-efficiency of the regeneration process of processes using precipitating solids that need to be dissolved in the regeneration step.

### SUMMARY OF THE INVENTION

The invention provides a process for the removal of CO₂ from a gas comprising CO₂, comprising the steps of: (a) contacting the gas in an absorber with an aqueous solution of one or more carbonate compounds in the presence of an accelerator, thereby reacting at least part of the CO₂ to form a bicarbonate compound, under conditions such that at least a part of the bicarbonate compound formed precipitates, forming a bicarbonate slurry; (b) subjecting at least part of the bicarbonate slurry to a concentration step to obtain the aqueous solution and a concentrated bicarbonate slurry, wherein the concentrated bicarbonate slurry comprises in the range of from 10 to 60 wt % of bicarbonate compounds; (c) returning at least part of the aqueous solution to the absorber; (d) transferring a first part of the concentrated bicarbonate slurry to a first heat exchanger, wherein the first part of the slurry is being heated against a hot lean solvent of a regenerator; (e) transferring a second part of the concentrated bicarbonate slurry to a second heat exchanger, wherein the second part of the slurry is being heated against a second heating source, which second heating source differs from the hot lean solvent of the regenerator; (f) transferring the heated first part and the heated second part of the concentrated bicarbonate slurry to the regenerator and heating concentrated bicarbonate slurry to obtain a CO₂-rich gas stream and a regenerated carbonate stream; and (g) returning the regenerated carbonate stream to the absorber of step (a).

The process advantageously enables a simple, energy-efficient removal of carbon dioxide from gases by efficiently integrating low temperature heat as heat medium in the process.

The process is further especially advantageous when the CO₂-rich absorbing solution contains solid compounds that need to be at least partly dissolved, before removing at least part of the CO₂ thereof in a regenerator, since their solvation requires extra energy.

The process is especially suitable for flue gas streams. The process enables removal of carbon dioxide from gases, e.g. flue gas, to low levels, resulting in a purified gas, which can be emitted to the atmosphere.

The process is further advantageous, because available heat from inside a capture and compression process may be used for the dissolution of the bicarbonate crystals. This reduces the energy consumption of the whole CO₂ capture process very significantly.

### BRIEF DESCRIPTION OF THE FIGURES

The invention is illustrated by the following figures:

FIG. 1 schematically shows a process scheme according to the prior art.

FIG. 2 shows a process scheme for one embodiment according to the invention.

### DETAILED DESCRIPTION OF THE INVENTION

In the process of the invention the obtained concentrated bicarbonate slurry is split and treated in at least two different heat exchangers. It is understood that both the first and the second heat exchanger each may comprise one or more heat exchangers in series, and preferably comprises in the range from one to three heat exchangers, more preferably one heat exchanger. It may further be that the heated first and second part are combined and further heated in another heat exchanger, before entering the regenerator.

It is however most preferred to split the concentrated bicarbonate slurry into two parts only, a first part and a second part, and that these two parts are heated in two different heat exchangers only that are aligned parallel, using different sources of heat to exchange the parts of the concentrated bicarbonate slurry with.

The first part of the concentrated bicarbonate slurry is being heated in the first heat exchanger preferably from at least 20° C., more preferably at least 30° C. to preferably at most 110° C., more preferably at most 100° C. The same is true for the second part: the second part of the concentrated bicarbonate slurry is being heated in the second heat exchanger preferably from at least 20° C., more preferably at least 30° C. to preferably at most 110° C., more preferably at most 100° C. The temperatures at the higher end are preferred because the regenerator is operated at slightly higher temperatures, to release the carbon dioxide from the absorbent.

The concentrated bicarbonate slurry formed in step (b) is thus divided into more parts to be heated separately. Preferably, it is divided into two parts. More preferably, the first part of the concentrated bicarbonate slurry is in the range of from 60 to 80 wt % of the concentrated bicarbonate slurry of step (b), and the second part of the concentrated bicarbonate slurry is in the range of from 20 to 40 wt % of the concentrated bicarbonate slurry of step (b). This split is advantageous, because up to 80% of the required heat is easily obtainable from the hot CO₂ lean solvent from the regenerator.

In the first heat exchanger the first part of the slurry is heated against the hot lean solvent of the regenerator. When heating the first part of the formed slurry, advantageously the CO₂ lean solvent produced in step (g) is simultaneously cooled to the temperature required in the absorber.

In the second heat exchanger the second part of the concentrated bicarbonate slurry is heated against a second heating source, which second heating source differs from the hot lean solvent of the regenerator. This second heating source is direct or indirect heat recovered from a condenser at the top of the regenerator, from CO₂ compressor interstage coolers, from feed gas to the absorber, from a condensate from a reboiler of the regenerator, from hot flue gas, or from integration from an industrial process, for example from a power plant, a refinery or a chemicals complex. Also combinations of these sources are possible. Preferably, the second heating source is direct or indirect heat recovered from the condenser at the top of the regenerator and or heat recovered directly or indirectly from the CO₂ compressor interstage coolers.

The aqueous solution in step a) comprises an aqueous solution of one or more carbonate compounds, wherein the absorbing solution absorbs at least part of the CO₂ in the gas by reacting at least part of the CO₂ in the gas with at least part of the one or more carbonate compounds in the aqueous solution to prepare a CO₂ rich absorbing solution comprising a bicarbonate compound.

The absorber is operated under temperature conditions such that the bicarbonate compound at least partly precipitates. The absorbing solution comprising the dissolved bicarbonate might subsequently be cooled to form bicarbonate crystals, before the concentration step, to improve the efficiency of the process.

The aqueous solution of one or more carbonate compounds preferably comprises in the range of from 2 to 60 wt %, more preferably in the range from 5 to 50 wt % of carbonate compounds.

The one or more carbonate compounds can comprise any carbonate compound that can react with CO₂. Preferred carbonate compounds include alkali or alkali earth carbonates, more preferred are Na₂CO₃ or K₂CO₃ or a combination thereof, as these compounds are relatively inexpensive, commercially available and show favourable solubilities in water.

The aqueous solution of one or more carbonate compounds further comprises an accelerator to increase the rate of absorption of CO₂. Suitable accelerators include compounds that enhance the rate of absorption of CO₂ from the gas into the liquid. The accelerator is preferably selected from the group of primary amines, secondary amines, amino acids, vanadium-containing compounds and borate containing compounds or combinations thereof. More preferably an accelerator comprises one or more compounds selected from the group of primary or secondary amino acids, borate acid containing compounds and saturated 5- or 6-membered N-heterocyclic compounds, which optionally contain further heteroatoms.

The process of the invention is especially advantageous for bicarbonate slurries, because dissolving the precipitated bicarbonate compound particles will require extra energy. The process according to the invention allows the use of energy obtained at a low temperature to dissolve bicarbonate crystals.

For the process of the invention it is required to subject at least part of the bicarbonate slurry to a concentration step to obtain an aqueous solution and a concentrated bicarbonate slurry. Without the concentration step the advantages of the process are limited. The higher bicarbonate loading of the adsorbent can only be reached by using this concentration step, as with the concentration step more solids per weight of absorbent is obtained. The concentrated bicarbonate slurry comprises in the range of from 10 to 60 wt % of bicarbonate compounds, preferably in the range of from 25 to 55 wt % of bicarbonate compounds, and more preferably in the range from 35 to 50 wt % of bicarbonate compounds.

Concentrating the bicarbonate slurry can be performed by any means known to the person skilled in the art. Examples are a settler or a hydrocyclone, or a combination of a vessel wherein further solids are formed, a so-called crystallizer, combined with a cyclone or settler. It is preferred to execute the concentration step by transferring at least part of the bicarbonate slurry to an agitated vessel, to form an agitated slurry, which agitated slurry is at least partly transferred to a separator wherein the agitated slurry is being separated into the aqueous solution and a separated agitated slurry. The aqueous solution is returned to the absorber column. The separated agitated slurry is returned to the agitated vessel, and is being mixed with the bicarbonate slurry to obtain the concentrated bicarbonate slurry. The advantage of executing the concentration step this way is that a very large solvent flow can be returned to the absorber column to reabsorb CO₂, while operating the agitated vessel at a high concentration of solids and sending a relatively small flow of concentrated bicarbonate slurry to the regenerator. The advantage of sending a relatively small flow of concentrated bicarbonate slurry to the regenerator is that superfluous water is not being heated and cooled down again, costing extra energy. A further advantage is that the loss of water through evaporation at the top of the regenerator is less.

It is furthermore preferred in the process of the invention that the aqueous solution obtained in step (c) is cooled to produce a cooled aqueous solution which is transferred to the absorber.

In some cases the process further comprises an additional step of pressurising the, preferably concentrated, CO₂-rich absorbing solution to obtain a pressurised CO₂-rich absorbing solution; subsequently heating the pressurised, CO₂-rich absorbing solution; and removing at least part of the CO₂ from the heated pressurised CO₂-rich absorbing solution in a regenerator in step f) to produce a CO₂-rich gas and a CO₂-lean absorbing solution, which CO₂-lean absorbing solution comprises an aqueous solution of one or more carbonate compounds.

In the process of the invention the regenerator is preferably operated at a higher temperature than the absorber. Preferably, the absorber is operated at a temperature in the range of from 10 to 80° C., more preferably in the range of from 25 to 70° C., even more preferably in the range of from 30 to 50° C. At these temperatures the conditions in the absorber are such that the bicarbonate formed precipitates at least partly at a given concentration of carbonate compounds in the aqueous solution.

Preferably, the regenerator is operated at a temperature sufficiently high to ensure that a substantial amount of CO₂ is liberated from the heated CO₂-rich absorption liquid. Preferably, the regenerator is operated at a temperature in the range from 60 to 170° C., more preferably from 80 to 160° C. and still more preferably from 100 to 140° C.

In the process of the invention the regenerator is might be operated at a higher pressure than the absorber. It is possible to operate the regenerator at elevated pressure, for example in the range of from 1.0 to 50 bar absolute, more preferably from 3 to 40 bar absolute, even more preferably from 5 to 30 bar absolute. Higher operating pressures for the regenerator might in some cases be preferred because the CO₂ rich gas exiting the regenerator will then also be at a high pressure.

Preferably the CO₂ rich gas produced in step (f) is at a pressure in the range of from 1.5 to 50 bar absolute, preferably from 3 to 40 bar absolute, more preferably from 5 to 30 bar absolute. Especially in applications where a CO₂ rich gas needs to be at a high pressure, for example when it will be used for injection into a subterranean formation, it is an advantage that such CO₂ rich gas is already at an elevated pressure as this reduces the equipment and energy requirements needed for further pressurisation.

In a preferred embodiment, pressurised CO₂ rich gas stream is used for enhanced oil recovery, suitably by injecting it into an oil reservoir where it tends to dissolve into the oil in place, thereby reducing its viscosity and thus making it more mobile for movement towards the producing well.

Optionally, the CO₂ rich gas obtained in step (f) is compressed to a pressure in the range of from 60 to 300 bar, more preferably from 80 to 300 bar. A series of compressors can be used to pressurise the CO₂ rich gas to the desired high pressures. A CO₂ rich gas which is already at elevated pressure is easier to further pressurise. Moreover, considerable capital expenditure is avoided because the first stage(s) of the compressor, which would have been needed to bring the CO₂ rich gas to a pressure in the range of 5 to 50 bar, is not necessary.

The gas comprising CO₂ contacted with the absorbing solution in step (a) can be any gas comprising CO₂. Examples include flue gases, synthesis gas and natural gas. The process is especially capable of removing CO₂ from flue gas streams, more especially flue gas streams having relatively low concentrations of CO₂ and comprising oxygen.

The partial pressure of CO₂ in the CO₂ comprising gas contacted with the absorbing solution in step (a) is preferably in the range of from 10 to 500 mbar, more preferably in the range from 30 to 400 mbar and most preferably in the range from 40 to 300 mbar.

An embodiment of the present invention will now be described by way of example only, and with reference to the accompanying Figures. For the purpose of this description, a single reference number will be assigned to a line as well as stream carried in that line.

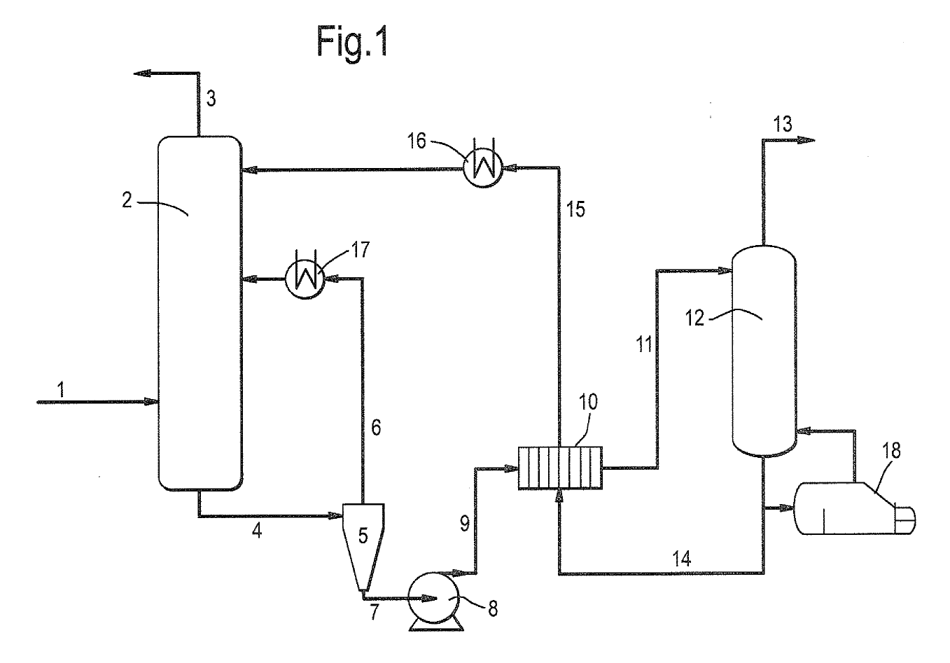

In FIG. 1 a process line-up according to the prior art is shown. Gas comprising CO₂ is contacted with an aqueous solution comprising of one or more carbonate compounds in an absorber. Gas is led via line (1) to absorber (2), where it is contacted with an aqueous solution of one or more carbonate compounds. In the absorber, CO₂ is reacted with the carbonate compounds to form bicarbonate compounds. At least part of the bicarbonate compounds precipitate to form a bicarbonate slurry. Treated gas leaves the absorber via line (3). The bicarbonate slurry is withdrawn from the bottom of the absorber and led via line (4) to a concentrating device (5). In the concentrating device (5), aqueous solution is separated from the bicarbonate slurry and led back to the absorber via line (6). The resulting concentrated slurry is led from the concentrating device via line (7) and pressurised in pump (8). The pressurised concentrated bicarbonate slurry is led via line (9) to a lean rich heat exchanger (10), where it is heated. The heated concentrated bicarbonate slurry is led via line (11) to regenerator (12), where it is further heated to release CO₂ from the slurry. Heat is supplied to the regenerator via reboiler (18) heating the solution in the lower part of the regenerator (12). The CO₂ is released from the regenerator via line (13). A CO₂ lean aqueous solution of one or more carbonate compounds (the hot lean solvent) is led from the regenerator (12) via line (14) to the heat exchangers (10), where it is cooled. The cooled CO₂ lean absorption solution is led via line (15) to lean solvent cooler (16) where it is further cooled and led to the absorber (2). The aqueous solution from the concentrating device (5) is led via line (6) to a solvent cooler (17) where it is further cooled and led to the absorber (2).

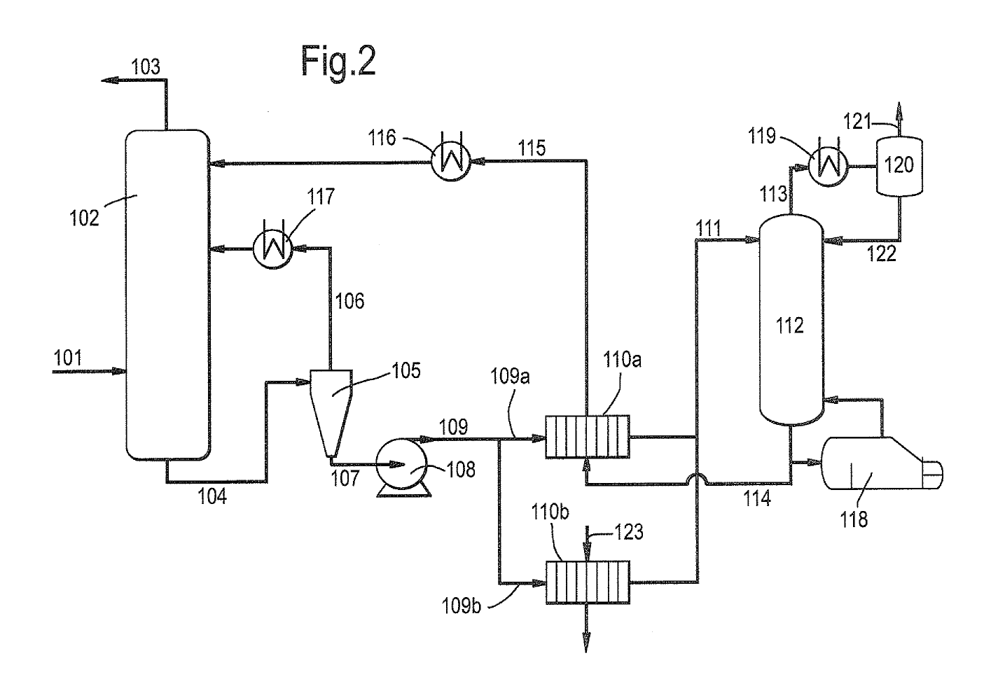

In FIG. 2 a preferred embodiment of the process line-up according to the invention is shown. Many components are similar to the prior art process line-up, but the major difference is in the way the heat integration has taken place. Gas comprising CO₂ is contacted with an aqueous solution comprising of one or more carbonate compounds in an absorber. Gas is led via line (101) to absorber (102), where it is contacted with an aqueous solution of one or more carbonate compounds. In the absorber, CO₂ is reacted with the carbonate compounds to form bicarbonate compounds. At least part of the bicarbonate compounds precipitate to form a bicarbonate slurry. Treated gas leaves the absorber via line (103). The bicarbonate slurry is withdrawn from the bottom of the absorber and led via line (104) to a concentrating device (105). In the concentrating device (105), aqueous solution is separated from the bicarbonate slurry and led back via line (106) to a solvent cooler (117) where it is further cooled and led to the absorber (102). The resulting concentrated slurry is led from the concentrating device via line (107) and might be pressurised in pump (108). The pressurised concentrated bicarbonate slurry is led via line (109) and split into two parts, a first part (109a) and a second part (109b). The first part is being led to heat exchanger (110a) where it is heated against the hot lean solvent (114) leaving the regenerator (112). The second part (109b) is led to heat exchanger (110b), where it is heated against a second source of heat (123). Both the heated parts are combined and led via line 111 to regenerator (112), where it is further heated to release CO₂ from the slurry. Heat is supplied to the regenerator via reboiler (118) heating the solution in the lower part of the regenerator (112). The CO₂ is released from the regenerator via line (113). The released CO₂ is led from the regenerator (112) via line (113) to a condenser (119) and a vapour-liquid separator (120) and is obtained as a CO₂-rich stream (121). The liquid is returned from separator (120) via line (122) to the regenerator (112). The CO₂ lean aqueous solution of one or more carbonate compounds (i.e. the hot lean solvent) is led from the regenerator (112) via line (114) to the heat exchanger (110a), where it is cooled. The cooled CO₂ lean absorption solution is led via line (115) to the absorber.

Using multiple heat exchangers in parallel provides an efficient way of heating op a loaded solvent stream which contains solids. The cold slurry flow is split in two streams. One of the streams is heated countercurrent by the hot lean solvent. The other stream is heated counter current by a separate stream, which separate stream is then cooled from eg 110° C. to 40° C. This allows for heat integration inside the capture plant by direct or indirect contacting with eg the condenser (119), or the condensate from the reboiler (118). The other stream may also be contacted with a hot medium eg from a quench cooler in the feed gas, or by integration with other sources of medium eg from the power plants or other operations on site.

In total this type of heat integration will reduce the energy consumption of the capture plant in the range of 0.5-1.5 MJ/kg, which may be as much as 50% of the overall energy required for regeneration of the solvent.

As an example, calculations and simulations were done to confirm the benefit of the line-up for a three phase separation process containing gas, solids and liquid, using a commercial flow skeeter. The absorbing solution in this example is heated from 30° C. to 97° C. The temperature of 97° C. is the envisaged temperature, at which the solution is, to enter the regenerator column. We calculated that for this, a total of 114 MW is required, assuming a commercial process which removes 1000 kt/a CO₂. Of the 114 MW that is required to heat the concentrated carbonate slurry, we have calculated that 79 MW can be recovered via a lean rich heat exchanger. The additional 35 MW needs to be made available from a different sources.

In the below examples, it is evaluated how much of the required duty can be recovered from the condenser of the regenerator and the CO2 compressor interstage coolers, as the different source.

### EXAMPLE 1 (COMPARATIVE)

In a conventional line-up, a first single lean rich heat exchanger was used, followed by a fat solvent heater, which is used to dissolve the solids present in the absorbing solution, before entering the regenerator. The first single lean rich heat exchanger heated the absorbent from 30 to 80° C., using the heated solvent returning from the regenerator (the CO₂ lean solvent). For this, 79 MW heat is required. Next, the absorbent was heated from 80 to 97° C. in the fat solvent heater, requiring a total of 35 MW of heat. To heat to this temperature with the fat solvent heater, duty recovered from the CO₂ condenser of the regenerator and the CO₂ compressor interstage coolers was used. It was calculated that only 9.6 MW of the required 35 MW could be recovered from these streams (for a four stage CO₂ compression process, in total 8.8 MW of heat can be recovered at a temperature above 90° C. and in total 0.8 MW can be recovered from the regenerator overhead condenser above 90° C.). The remaining 25.4 MW still needed to come from a different source, like low pressure steam from a source outside the line-up.

### EXAMPLE 2 (COMPARATIVE)

In a so-called double lean rich heat exchanger designed line-up the absorbent is heated from 30° C. to 97° C. using a first single lean rich heat exchanger, followed by a fat solvent heater, followed by a second lean rich heat exchanger, before entering the regenerator column.

The first single lean rich heat exchanger heated the absorbent from 30° C. to 68° C., by contacting with the CO₂ lean solvent that was already used in the second heat exchanger. This required 56 MW of duty. The next heating step was contacting the absorbent in the fat solvent heater, to heat the absorbent from 68° C. to 88° C. This required a duty of 35 MW, for which duty recovered from the condenser of the regenerator and the CO₂ compressor interstage coolers where used. Only 12.1 MW of the required 35 MW could be recovered from these streams (assuming an approach of 10° C., the heating medium can be cooled to 78° C., which lead to an amount of 10.7 MW from the compressor and 1.4 MW can be recovered from the regenerator condenser). The remaining 22.9 MW still needed to come from a different source. Finally the absorbent was heated from 88° C. to 97° C. in the second lean rich heat exchanger, by contacting with the CO₂ lean solvent directly from the regenerator. This required a duty of 23 MW.

### EXAMPLE 3 (ACCORDING TO THE INVENTION)

In the process according to the invention the first part of the concentrated bicarbonate slurry is transferred to the first heat exchanger where it is heated against the hot lean solvent of the regenerator column. In this case 69 wt % of the concentrated bicarbonate slurry is being heated from 30 to 97° C. in one step in the lean rich heat exchanger. The required duty is 79 MW.

The second part of the concentrated of the concentrated bicarbonate slurry, being 31 wt %, is transferred to a second heat exchanger. Here it is heated from 30 to 97° C. using the heat from the regenerator condenser and the CO₂ compressor interstage coolers. This required 35 MW. An amount of 43.6 MW of the required 35 MW could be recovered from these streams. Again assuming an approach of 10° C., the heating medium is in this case cooled to 40° C. From the compressor coolers, a total of 19.6 MW is recovered. From the regenerator overhead condensor, a total of 24 MW is recovered. In total 43.6 MW is recovered, which exceeds the required heat by 25%. Thus in the process according to the invention, the recoverable heat is much higher and the heat required from additional sources is much lower.

All the results of the calculations are summarized in Table 1 below.

TABLE 1
Overview of the results of the 3 examples

| | Total | Duty | | | T | T out | | | | |
|---|---|---|---|---|---|---|---|---|---|---|
| | duty | lean | Duty | T in | out | cooled | Recoverable | Recoverable | Total | Recoverable |
| | for | rich | 2^{nd} | 2^{nd} | 2^{nd} | process | duty CO₂ | duty | recoverable | % of heat |
| | heating | HX¹ | HX¹ | HX¹ | HX¹ | stream | compressor | regenerator | heat | required |
| Ex. | MW | MW | MW | ° C. | ° C. | ° C. | MW | MW | MW | % |
| 1 | 114 | 79 | 35 | 80 | 97 | 90 | 8.8 | 0.8 | 9.6 | 27 |
| 2 | 114 | 56 + 23 | 35 | 68 | 88 | 78 | 10.7 | 1.4 | 12.1 | 35 |
| 3 | 114 | 79 | 35 | 30 | 97 | 40 | 19.6 | 24 | 43.6 | 125 |

¹HX = heat exchanger

1. A process for the removal of CO₂ from a gas comprising CO₂, comprising the steps of:
(a) contacting the gas in an absorber with an aqueous solution of one or more carbonate compounds in the presence of an accelerator, thereby reacting at least part of the CO₂ to form a bicarbonate compound, under conditions such that at least a part of the bicarbonate compound formed precipitates, forming a bicarbonate slurry;
(b) subjecting at least part of the bicarbonate slurry to a concentration step to obtain the aqueous solution and a concentrated bicarbonate slurry, wherein the concentrated bicarbonate slurry comprises in the range of from 10 to 60 wt % of bicarbonate compounds;
(c) returning at least part of the aqueous solution to the absorber;
(d) transferring a first part of the concentrated bicarbonate slurry to a first heat exchanger, wherein the first part of the slurry is being heated against a hot lean solvent of a regenerator;
(e) transferring a second part of the concentrated bicarbonate slurry to a second heat exchanger, wherein the second part of the slurry is being heated against a second heating source, which second heating source differs from the hot lean solvent of the regenerator;
(f) transferring the heated first part and the heated second part of the concentrated bicarbonate slurry to the regenerator and heating concentrated bicarbonate slurry to obtain a CO₂-rich gas stream and a regenerated carbonate stream; and
(g) returning the regenerated carbonate stream to the absorber of step (a).

2. A process according to claim 1, wherein the one or more carbonate compounds include Na₂CO₃ or K₂CO₃ or a combination thereof.

3. A process according to claim 1 or 2, wherein the aqueous solution of one or more carbonate compounds comprises in the range of from 2 to 60 wt % of carbonate compounds.

4. A process according to claim 1, wherein the first part of the concentrated bicarbonate slurry is in the range of from 60 to 80 wt % of the concentrated bicarbonate slurry of step (b), and the second part of the concentrated bicarbonate slurry is in the range of from 20 to 40 wt % of the concentrated bicarbonate slurry of step (b).

5. A process according to claim 1, wherein the absorber is operated at a temperature in to range of from 10 to 80° C., preferably in the range of from 25 to 70° C.

6. A process according to claim 1, wherein the second heating source is direct or indirect heat recovered from the condenser at the top of the regenerator and or heat recovered directly or indirectly from the CO₂ compressor interstage coolers.

7. A process according to claim 1, wherein the accelerator is selected from the group of primary amines, secondary amines, amino acids, vanadium-containing compounds and borate-containing compounds.

8. A process according to claim 1, wherein the aqueous solution of step (c) is cooled to produce a cooled aqueous solution which is transferred to the absorber.

9. A process according to claim 1, wherein the first part of the concentrated bicarbonate slurry is being heated in the first heat exchanger from at least 20° C.

10. A process according to claim 1, wherein the second part of the concentrated bicarbonate slurry is being heated in the second heat exchanger from at least 20° C.

11. A process according to claim 1, wherein the concentration step comprises transferring at least part of the bicarbonate slurry to an agitated vessel, to form an agitated slurry, which agitated slurry is at least partly transferred to a separator wherein the agitated slurry is being separated into the aqueous solution and a separated agitated slurry, which separated agitated slurry is returned to the agitated vessel, and is being mixed with the bicarbonate slurry to obtain the concentrated bicarbonate slurry.

12. A process according to claim 1, wherein the CO₂ rich gas obtained in step (f) is compressed to a pressure in the range of from 60 to 300 bar.

13. A process according to claim 11, wherein compressed CO₂ rich gas is injected into a subterranean formation.
